(19) United States
(12) Patent Application Publication
(10) Pub. No.: US 2014/0224188 A1
(43) Pub. Date: Aug. 14, 2014

(54) DOG LEASH

(71) Applicant: HOOK ME UP, LLC, Santa Ana, CA (US)

(72) Inventors: Andrew Upah, Capistrano Beach, CA (US); Melissa Melfi, Capistrano Beach, CA (US); Francesco Venezia, New York City, NY (US)

(73) Assignee: HOOK ME UP, LLC, Santa Ana, CA (US)

(21) Appl. No.: 13/766,534

(22) Filed: Feb. 13, 2013

(51) Int. Cl. A01K 27/00

(52) U.S. Cl. CPC A01K 27/003
USPC 119/795

(57) ABSTRACT

A leash is provided having a handle that can be disassembled by removing a clasp of the handle from an attachment point. The clasp can be attached to any one of a plurality of attachment points along a length of the strap of the leash to secure a pet to a stationary object while maintaining control of the pet. This provides for a quick and easy system to secure the pet to the stationary object.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a leash for an animal.

Our pets become a part of our family and we travel with them everywhere we go. Local rules may require the pet owner to always be in control of his or her pet in public areas for the safety of the animal as well as others. As such, animals such as dogs are placed on a leash to maintain control of the dog in public areas. While traveling with a pet, the pet owner must sometimes utilize both hands to accomplish a task such as opening or locking a car door or the front door of a home. The pet owner may also have to search through a purse or pocket for car or home keys. In these instances, it may be beneficial to perform such task with both hands. However, the pet owner must always maintain control of his or her pet regardless of the need or preference to use both hands. To do so, the pet owner must always grasp a handle of the leash thereby controlling the pet but doing so may prohibit the pet owner from performing a task with both hands.

In other instances, a store such as a grocery store or coffee shop may prohibit entrance of a pet. The pet owner must secure the pet to a stationary object by removing the leash from the pet collar and wrapping the leash around a stationary object while looping the leash through the handle and attaching the leash back to the pet collar. During this procedure, the dog may resist or be distracted. The pet owner may lose control of the dog thereby placing the dog and pedestrians in danger.

Accordingly, there is a need in the art for an improved dog leash.

### BRIEF SUMMARY

The leash described herein addresses the needs discussed above, discussed below and those that are known in the art.

The leash may have a strap having a plurality of attachment points for forming a handle of the leash. The attachment points may also be used to secure the leash and pet to a stationary object while allowing the pet owner to maintain control of the pet during the securing process. The leash may define first and second end portions. The first end portion is removably attachable to a collar of the pet. The second end portion may have a clasp that can be removably attached to any one of the plurality of attachment points. The handle of the leash is formed when the clasp is attached to the closest attachment point. When the pet owner wants to secure the pet to a stationary object, the pet owner while gripping the strap releases the clasp from the closest attachment point, wraps the leash around the stationary object and attaches the clasp to one of the attachment points on the strap depending on the size of the stationary object. In this manner, the pet owner maintains control of the pet at all times with one hand while securing the pet to the stationary object.

More particularly, a leash is disclosed that is capable of tethering an animal to a stationary object when its handler needs to be momentarily separated from the animal or requires use of both hands. The leash may comprise a handle, an elongate flexible strap, a clasp and a hook. The handle is provided for holding the leash. The elongate flexible strap may define opposed first and second end portions. The first end portion may be attached to the handle. The strap may have one or more attachment points disposed along a length of the strap. The clasp of the handle may be removably attached to any one of the attachment points. The hook may be attached to the second end portion of the strap and operative to removably attach the leash to a collar of the animal.

The attachment points may be rings attached to the strap via loops. Alternatively, the attachment points may be loops. At least three attachment points may be disposed along the length of the strap. The attachment point closest to the handle may form the handle when the clasp of the handle is attached to such attachment point. The attachment points may be equidistant from each other.

In another aspect, a method of securing an animal to a stationary object is disclosed. The method may comprise the steps of detaching a clasp of a handle of the leash from a proximal attachment point along a length of a strap of the leash; wrapping the strap of the leash around the stationary object; and attaching the clasp of the handle of the leash to a distal attachment point along the length of the strap of the leash.

The method may further comprise the step of grasping the strap at a location closer to the animal than a position of the attachment point to which the clasp will be attached to maintain control of the animal while securing the animal to the stationary object.

In the method, the detaching step may include the step of disassembling the handle.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a person holding a first embodiment of a leash attached to a dog for controlling the dog;

FIG. 2 illustrates the dog secured to a table with the leash shown in FIG. 1;

FIG. 3 is an enlarged view of the handle shown in FIG. 1;

FIG. 4 is an enlarged view of a clasp of the handle attached to an attachment point;

FIG. 5 is an enlarged view of the clasp of the handle attached to a different attachment point; and

FIG. 6 illustrates the person holding a second embodiment of the leash.

### DETAILED DESCRIPTION

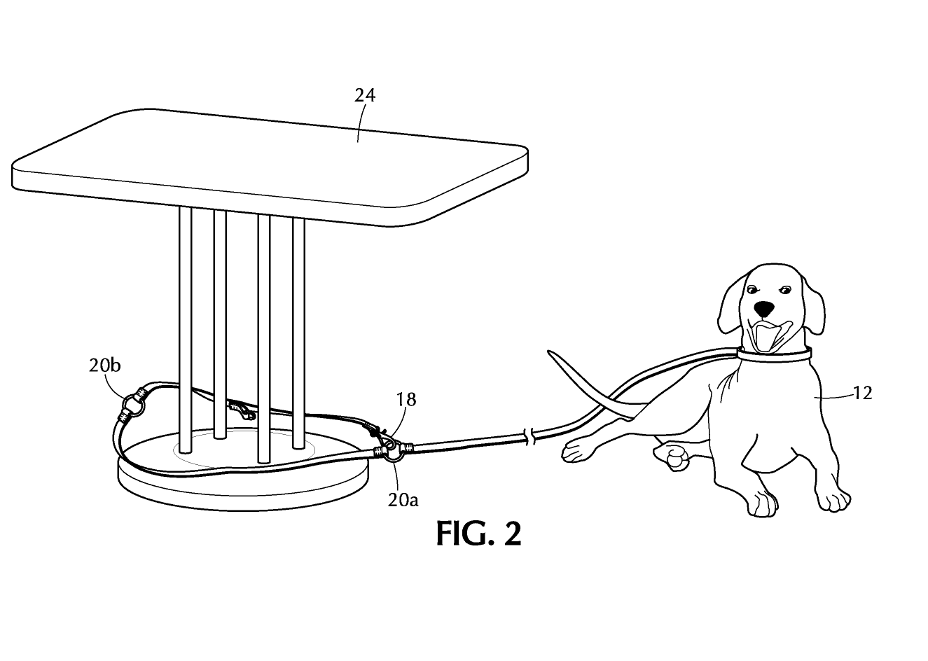

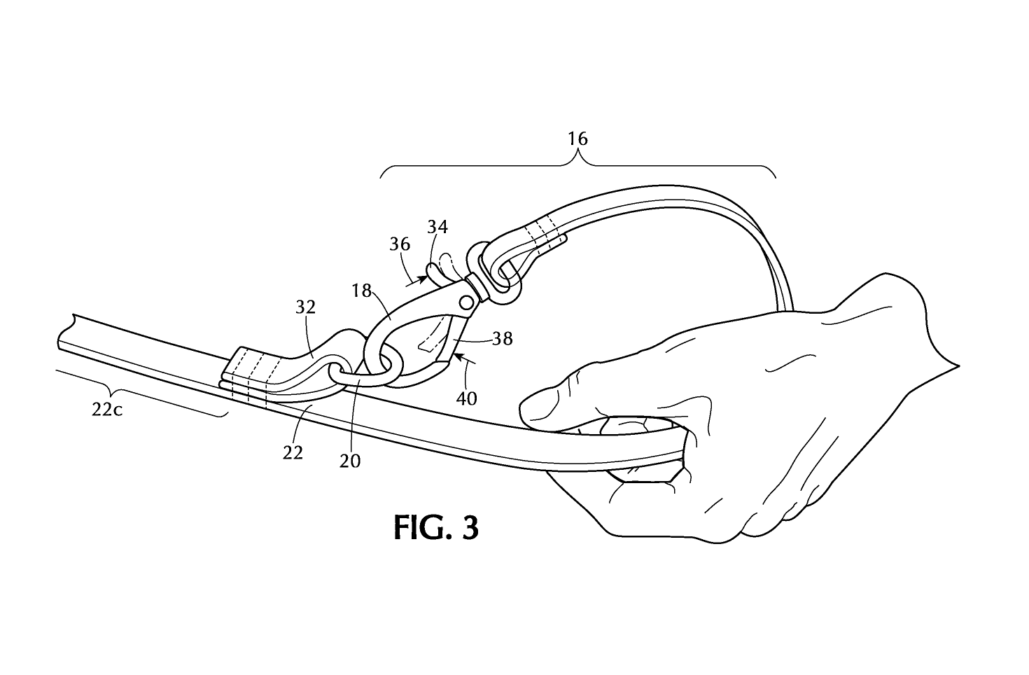

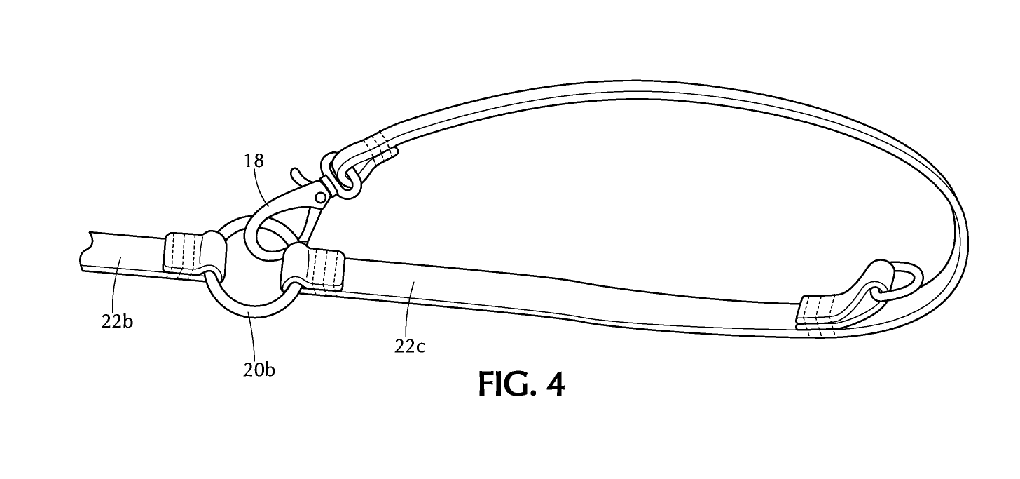

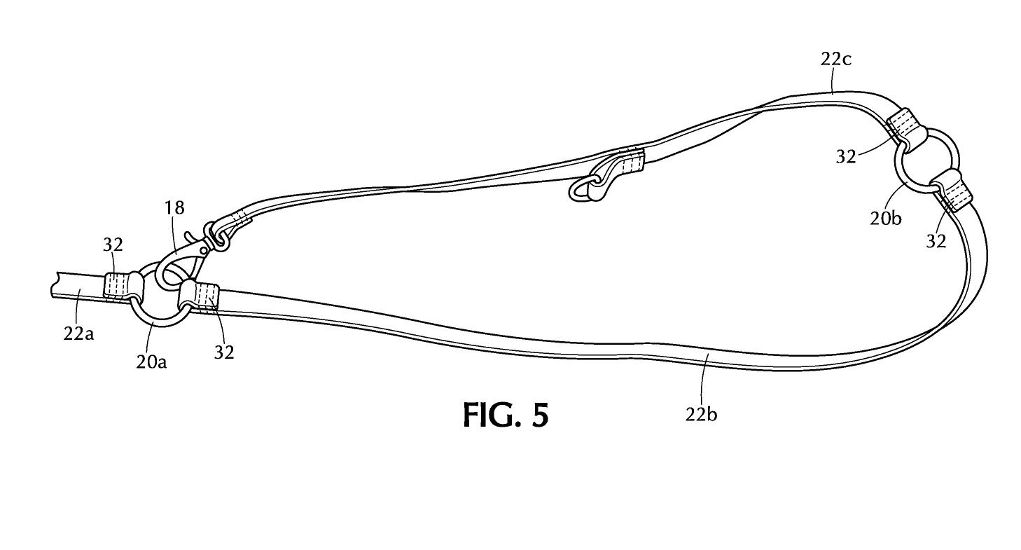

Referring now to the drawings, a leash 10 is shown which is attached to a dog 12 and held by a person 14 to control the dog 12 so that the dog 12 cannot run away from the person 14. The person 14 can hold the dog 12 back by pulling on the leash 10. The leash 10 has a handle 16 that can be disassembled by unhooking a clasp 18 from a ring 20 (see FIG. 3). A strap 22 of the leash 10 may have one or more intermediate rings 22 to which the clasp 18 may be secured, as shown in FIGS. 4 and 5. As such, when the person 14 needs to utilize both hands, the person 14 may secure the dog 12 to a stationary object (e.g. table 24) by encircling the stationary object and hooking the clasp 18 to one of the rings 20a, b disposed on a length of the strap 22, as shown in FIG. 2. In this manner, the dog 12 may be secured to the stationary object when the person 14 leaves the pet outside to purchase a product in a store (e.g., coffee shop), opens a door, unloads groceries from a car and many other activities that require a pet owner 14 to be separated from the pet and/or to utilize both hands without losing control of the pet 12. The pet 12 is under control and is kept at a safe location and cannot run out into a dangerous street. Also, pedestrians will feel safe around the pet 12. Moreover, the pet owner 14 can comply with local laws and ordinances that require the pet owner 14 to maintain control of his or her pet 12 at all times.

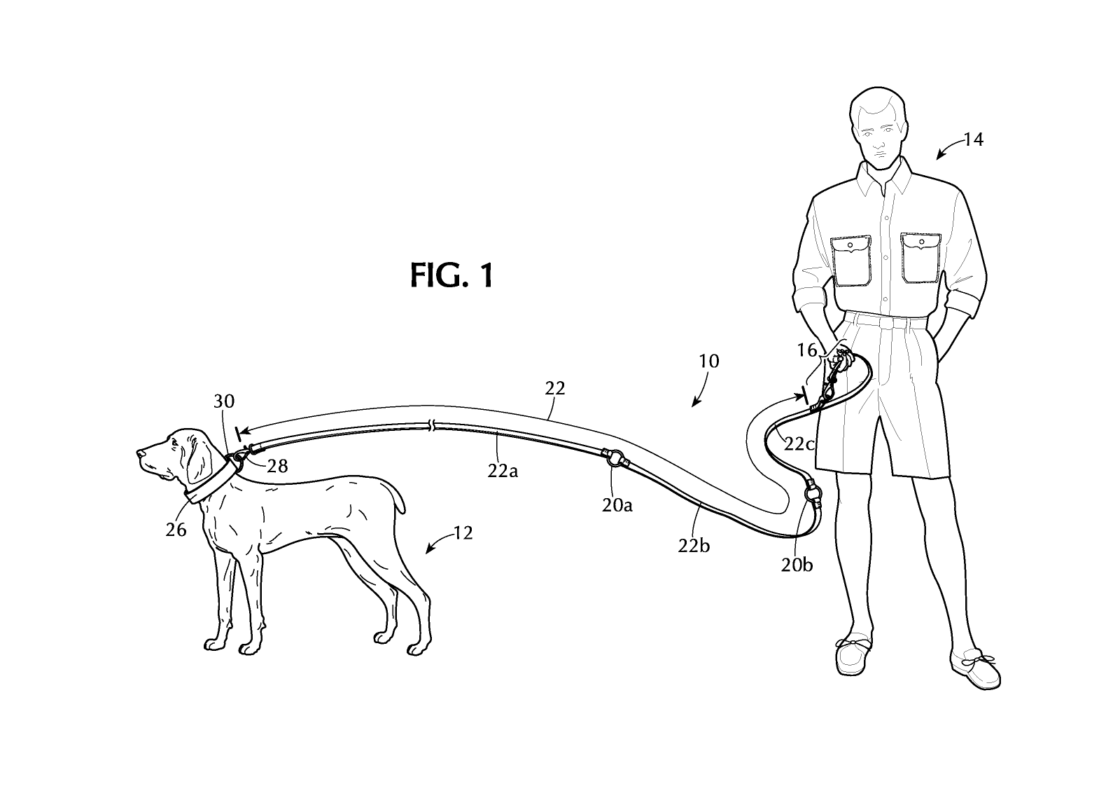

More particularly, referring now to FIG. 1, the pet owner 14 may secure the leash 10 to his or her pet 12. The pet 12 may have a collar 26 secured around its neck. The distal end of the strap 22 may have a clasp 28 removably attachable to a ring 30 attached to the dog collar 26.

The strap 22 may be elongate and flat. The strap 22 may be fabricated from any flexible material such as a nylon webbing, polypropylene webbing or cotton webbing. It is also contemplated that the strap 22 may also be fabricated from a round cord. The strap 22 may be fabricated and provided in various lengths between 2 feet and 10 feet or more. Also, the strap 22 may be fabricated and provided in various widths (e.g. 1/4 inch width-1 inch width or more).

The strap 22 may define three separate parts 22a, 22b and 22c. Ring 20a may be used to connect strap 22a to strap 22b. In particular, the proximal end of the strap 22a may be looped around the ring 20a and attached to itself, as shown in FIG. 5. The distal end of the strap 22b may also be wrapped around the ring 20a and attached to itself. As shown in FIG. 4, the proximal end of strap 22b and the distal end of strap 22c may be secured to ring 20b by looping the respective ends around the ring 20b and stitching the respective straps 22b, c upon itself or through other attachment means known in the art or developed in the future. The respective lengths of the straps 22a, b, c may be varied. In other words, the rings 20a, b may be disposed closer to or further away from the handle 16. By way of example and not limitation, the rings 20, 20a, b may be equidistant from each other and the ring 30. In other words, the lengths of straps 22a, b, c are equal to each other. Alternatively, it is also contemplated that the lengths of strap 22c and b be equal to each other and that strap 22a be longer than any one of straps 22b, c. By way of example and not limitation, the lengths of each of the straps 22b and 22c may be one foot, whereas the length of the strap 22a may be 3 feet or more. In a further alternative, the length of strap 22a may be about 25 inches. The length of strap 22b may be about 24 inches. The length of strap 22c may be about 8 inches. The length of the strap between the clasp 18 and the ring 20 may be about 10 inches.

Referring now to FIG. 3, the strap portion 22c may be continuous with the handle 16. At the proximal end of the strap portion 22c, a loop 32 may be formed and stitched to the proximal end of the strap portion 22c or a base of the handle 16. The loop 32 may be fabricated from the same material as the strap 22. The loop 32 may optionally have a ring 20 to which the clasp 18 may be attached. Alternatively, the clasp 18 may be directly attached to loop 32. When the clasp 18 is secured to the ring 20, the handle 16 is formed so that the person 14 may grab the handle 16 to control the animal 12.

When the person 14 needs use of both hands, the person 14 may secure the leash 10 to a stationary object. In FIG. 2, the stationary object is shown as being a table 24. The leash 10 is secured around the legs of the table 24. To secure the leash 10 around the stationary object, the person 14 presses on an optional handle 34 in the direction of arrow 36 (see FIG. 3) to pivot a gate 38 of the clasp 18 so that the clasp 18 may be unhooked from the ring 20. Alternatively, the gate 38 may be pushed in direction 40 with the person's thumb or finger to open the gate 38. After the clasp 18 is unhooked from the ring 20, the strap 20a, b may be wrapped around a stationary object and the clasp 18 may be secured to either one of rings 20a or 20b as shown in FIGS. 4 and 5. The person 14 may unhook the clasp 18 with one hand while gripping the strap 20a with the other hand to maintain control of the pet 12.

The rings 20, 20a, b discussed herein may be fabricated from a metallic material (e.g., aluminum, steel). The rings 20, 20a, b may form a complete circle so that the straps 22a, b, c or the clasp 18 of the handle 16 does not accidentally slip off of the rings 20, 20a, b. The rings 20, 20a, b may have a round configuration but the rings 20, 20a, b may also have other configurations such as rectangular, square, triangular, and polygonal. It is also contemplated that the rings 20, 20a, b may be fabricated from other materials such as nylon, fabric. In this instance, the rings 20, 20a, b are flexible and would not hold any particular shape.

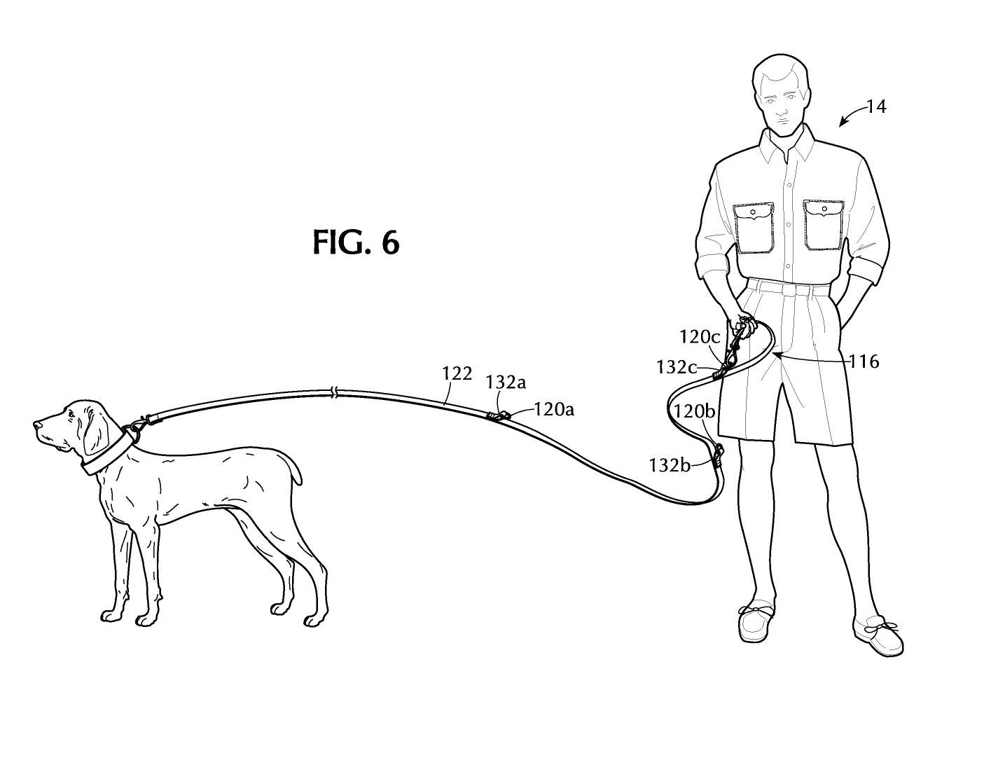

Referring now to FIG. 6, a second embodiment of the leash 100 is shown. The leash has a single length of strap 122, instead of three separate straps 22a, b, c as discussed in the first embodiment. The strap 122 may have three loops 132a, b, c attached to the strap 122 at different positions. The loop 132c is attached closest to the handle 116. When the clasp 18 of the handle 116 is attached to the loop 132c, the handle 116 is formed and provides the gripping area for the person 14 to hold the leash 100. The loops 132b, c are attached to the strap 122 further away from the handle 116. The clasp 18 of the handle 116 may be removed from the loop 132c so that the leash 100 can be wrapped around a stationary object and reattached to either one of the loops 132a, b to tether the dog 12 to the stationary object. The loops 132a, b, c may be attached to the strap 122 by stitching or other means known in the art or developed in the future.

The loops 132a, b, c may each have rings 120a, b, c attached thereto so that the clasp 18 may be more easily secured to the loops 132a, b, c. The loops 132a, b, c are each wrapped around the respective rings 120a, b, c and attached to the strap 122 to secure both the loops 132a, b, c and the rings 120a, b, c to the strap 122. However, it is also contemplated that the clasp 18 of the handle 116 may be directly attached to the loops 132a, b, c itself without the rings 120a, b, c.

The clasp 18 described herein has a body and a gate 38 which can be traversed between an opened position and a closed position. The gate 38 may be biased to the closed position. The clasp 18 may have the handle 34 to assist in opening and closing of the gate 38. The handle 34 is an optional feature of the clasp. The clasp 18 may include but is not limited to carabiners, locking carabiners, clamps that selectively opens and closes, and other devices known in the art or developed in the future.

The leash 10, 100 has been described and shown in relation to dogs. However, the leash 10, 100 may be used for any type of animal including but not limited to cats, wild animals, and monkeys.

The leash 10, 100 described herein incorporated one attachment point closest to the handle 16 for forming the handle 16 and two attachment points along the length of the strap 22, 122 to attach the clasp 18 thereto for securing the leash 10, 100 and the pet 12 to a stationary object. However, it is also contemplated that the leash 10, 100 may have one or more attachment points along the length of the strap 22, 122 for the purposes of providing more options to the pet owner in attaching the clasp 18 when securing the leash 10, 100 and pet 12 to the stationary object.

The above description is given by way of example, and not limitation. Given the above disclosure, one skilled in the art could devise variations that are within the scope and spirit of the invention disclosed herein, including various ways of attaching the loops to the strap. Further, the various features of the embodiments disclosed herein can be used alone, or in varying combinations with each other and are not intended to be limited to the specific combination described herein. Thus, the scope of the claims is not to be limited by the illustrated embodiments.

1. A leash for an animal to tether the animal to a stationary object when its handler needs to be momentarily separated from the animal or requires both hands and cannot firmly hold the leash to maintain control of the animal, the leash comprising:
a handle for holding the leash;
an elongate flexible strap defining opposed first and second end portions, the first end portion being attached to the handle, the strap having one or more attachment points disposed along a length of the strap;
a clasp of the handle removably attachable to any one of the one or more attachment points;
a hook attached to the second end portion of the strap and operative to removably attach the leash to a collar of the animal.

2. The leash of claim 1 wherein the attachment points are rings attached to the strap via loops.

3. The leash of claim 1 wherein at least three attachment points are disposed along the length of the strap, the attachment point closest to the handle forming the handle when the clasp of the handle is attached to the attachment point closest to the handle.

4. The leash of claim 3 wherein the three attachment points are equidistant from each other.

5. The leash of claim 1 wherein the attachment points are loops.

6. A method of securing an animal to a stationary object, the method comprising the steps of:
detaching a clasp of a handle of the leash from a proximal attachment point along a length of a strap of the leash;
wrapping the strap of the leash around the stationary object; and
attaching the clasp of the handle of the leash to a distal attachment point along the length of the strap of the leash.

7. The method of claim 6 further comprising the step of grasping the strap at a location closer to the animal than a position of the attachment to which the clasp is being attached to maintain control of the leash and animal while securing the animal to the stationary object.

8. The method of claim 6 wherein the detaching step includes the step of disassembling the handle.
